(19) United States
(12) Patent Application Publication
(10) Pub. No.: US 2025/0165335 A1
(43) Pub. Date: May 22, 2025

(54) METHOD AND DEVICE FOR PROCESSING DATA

(71) Applicant: Robert Bosch GmbH, Stuttgart (DE)

(72) Inventor: Henrik Klessig, Renningen (DE)

(21) Appl. No.: 18/840,214

(22) PCT Filed: Mar. 22, 2023
(86) PCT No.: PCT/EP2023/057321

§ 371 Date: Aug. 21, 2024

(30) Foreign Application Priority Data
Apr. 12, 2022 (DE) 10 2022 203 656.5

(51) Int. Cl. G06F 11/07

(52) U.S. Cl. CPC G06F 11/0793; G06F 11/0709

(57) ABSTRACT

A method for processing data associated with an application that at least intermittently uses a communication system for data transfer with at least one other unit, for example a manufacturing device. The method includes: receiving first information which characterizes a self-healing process, for example an imminent self-healing process or a self-healing process which is already being carried out, the self-healing process being associated with at least one component of the communication system, and optionally controlling the operation of the application on the basis of the first information.

### FIELD

The present invention relates to a method, for example a computer-implemented method, for processing data associated with an application.

The present invention further relates to a device for processing data associated with an application.

### SUMMARY

Exemplary embodiments of the present invention relate to a method, for example a computer-implemented method, for processing data associated with an application that at least intermittently uses a communication system for data exchange with at least one other unit, for example a manufacturing device, the method comprising: receiving first information which characterizes a self-healing process, for example an imminent self-healing process or a self-healing process which is already being carried out, said self-healing process being associated with at least one component of the communication system, and, optionally, controlling the operation of the application on the basis of the first information. As a result, in further exemplary embodiments, a possibly occurring self-healing process of at least one component of the communication system, which self-healing process could, for example, have an effect on the application, can be taken into account, e.g. for the operation of the application. For example, in further exemplary embodiments, the operation of the application can thus be adapted to the self-healing process.

In further exemplary embodiments of the present invention, the application is associated with a manufacturing execution system, for example a manufacturing control system, for example at least intermittently executes at least one function for the manufacturing execution system, for example the manufacturing control system.

In further exemplary embodiments of the present invention, the self-healing process is an event that contributes to restoring operability of the at least one component of the communication system.

In further exemplary embodiments of the present invention, the communication system is e.g. a wireless, e.g. cellular, communication system, e.g. mobile communication system, e.g. according to a 4G (fourth generation) or 5G (fifth generation) standard, e.g. compatible with and/or based on 3GPP TS 32.541, or according to another standard, e.g. a future 6G standard.

In further exemplary embodiments of the present invention, the self-healing process can be designed, for example, according to and/or on the basis of 3GPP TS 32.541, Release 15; see e.g. 3GPP TS 32.541 V15.0.0 (2018-10), there e.g. FIG. 4.1.3-1.

In further exemplary embodiments of the present invention, the controlling comprises at least one of the following elements: a) determining whether a fail-safe state, for example a failure-resistant state, should be assumed, for example for the application and/or at least one component, e.g. of a manufacturing device associated with the application (e.g. controlled by the application), and, optionally, assuming the fail-safe state, b) backing up at least one portion of the data which are associated with the application, wherein, for example, the at least one portion comprises, for example, configuration data and/or state data. In further exemplary embodiments, the backed-up data can be used, for example, for a transition of the application from a fail-safe state to a regular operating state.

In further exemplary embodiments of the present invention, the method comprises: receiving second information which characterizes a completion of the self-healing process associated with the at least one component of the communication system, and, optionally, controlling the operation of the application on the basis of the second information.

In further exemplary embodiments of the present invention, the controlling of the operation of the application on the basis of the second information comprises at least one of the following elements: a) loading the at least one portion of the data which are associated with the application, for example from a previous backup, b) exiting the fail-safe state, for example switching from the fail-safe state to a regular operating state.

In further exemplary embodiments of the present invention, the method comprises at least one of the following elements: a) subscribing to the first information and/or the second information, for example registering to receive the first information and/or the second information, for example with at least one component, for example a service, of the communication system, b) deregistering from receiving the first information and/or the second information, for example with the at least one component, for example a service, of the communication system.

Further exemplary embodiments of the present invention relate to a method, for example a computer-implemented method, for processing data of a communication system that can be and/or is used at least intermittently by an application for data exchange with at least one other unit, for example a manufacturing device, the method comprising: sending first information which characterizes a self-healing process associated with at least one component of the communication system, for example an imminent self-healing process or a self-healing process which is already being carried out, for example to the application.

In further exemplary embodiments of the present invention, the method comprises: determining whether a self-healing process associated with at least one component of the communication system is imminent or is already being carried out.

In further exemplary embodiments of the present invention, the method comprises: determining whether the self-healing process associated with the at least one component of the communication system is completed, and, optionally, sending second information, on the basis of the determining, for example to the application.

In further exemplary embodiments of the present invention, the method comprises at least one of the following elements: a) receiving a registration for receiving the first information and/or the second information, from the application, b) receiving a deregistration from receiving the first information and/or the second information, from the application.

Further exemplary embodiments of the present invention relate to a device for performing the method according to at least one of the above-described embodiments.

Further exemplary embodiments of the present invention relate to a device for a manufacturing control system and/or a manufacturing device, comprising at least one device according to the embodiments.

Further exemplary embodiments of the present invention relate to a device for a communication system, comprising at least one device according to the embodiments.

Further exemplary embodiments of the present invention relate to a communication and manufacturing system, for example an integrated communication and production system, comprising at least one device according to the embodiments and/or at least one device for a manufacturing control system and/or a manufacturing device, optionally a or the manufacturing control system and/or the manufacturing device, and/or at least one device for a communication system, optionally the communication system.

Further exemplary embodiments of the present invention relate to a computer-readable storage medium comprising commands that, when executed by a computer, cause said computer to perform the method according to the embodiments.

Further exemplary embodiments of the present invention relate to a computer program comprising commands that, when the program is executed by a computer, cause said computer to perform the method according to the embodiments.

Further exemplary embodiments of the present invention relate to a data carrier signal that transmits and/or characterizes the computer program according to the embodiments.

Further exemplary embodiments of the present invention relate to a use of the method according to the embodiments and/or of the device according to the embodiments and/or of the communication Substitute Specification and manufacturing system according to the embodiments and/or of the computer-readable storage medium according to the embodiments and/or of the computer program according to the embodiments and/or of the data carrier signal according to the embodiments for at least one of the following elements: a) processing data associated with an application that at least intermittently uses a communication system for data exchange with at least one other unit, for example a manufacturing device, b) informing the application about the self-healing process, c) informing the application about a completion of the self-healing process, d) taking the self-healing process into account for the operation of the application, e) increasing the failure resistance of the application, f) reducing a downtime of the application, for example minimizing a downtime of the application due to a fault in the area of the communication system, g) accelerating a resumption of regular operation of the application, for example after a self-healing process of the communication system, h) extending an application of self-healing processes which are associated with the communication system to the application or the manufacturing device, i) coupling self-healing processes which are associated with the communication system to the application and/or the manufacturing device and/or a or the manufacturing execution system, for example a manufacturing control system, j) reducing, for example minimizing, human interaction or intervention, for example to transfer the application to a regular operating state, k) preventing communication attempts, for example a number of communication attempts exceeding a predefinable amount of communication attempts, of the application, e.g. in the event of a fault in the area of the communication system.

Further features, possible applications and advantages of the present invention will be apparent from the following description of exemplary embodiments of the present invention shown in the figures of the drawings. In this case, all of the features described or shown form the subject matter of the present invention individually or in any combination, irrespective of their wording or representation in the description herein or in the figures.

### BRIEF DESCRIPTION OF THE DRAWINGS

FIG. 1 schematically shows a simplified flowchart according to exemplary embodiments of the present invention.

FIG. 2 schematically shows a simplified block diagram according to further exemplary embodiments of the present invention.

FIG. 3 schematically shows a simplified flowchart according to further exemplary embodiments of the present invention.

FIG. 4 schematically shows a simplified flowchart according to further exemplary embodiments of the present invention.

FIG. 5 schematically shows a simplified flowchart according to further exemplary embodiments of the present invention.

FIG. 6 schematically shows a simplified flowchart according to further exemplary embodiments of the present invention.

FIG. 7 schematically shows a simplified flowchart according to further exemplary embodiments of the present invention.

FIG. 8 schematically shows a simplified flowchart according to further exemplary embodiments of the present invention.

FIG. 9 schematically shows a simplified block diagram according to further exemplary embodiments of the present invention.

FIG. 10A schematically shows a simplified block diagram according to further exemplary embodiments of the present invention.

FIG. 10B schematically shows a simplified block diagram according to further exemplary embodiments of the present invention.

FIG. 11 schematically shows a simplified block diagram according to further exemplary embodiments of the present invention.

FIGS. 12A and 12B schematically show a simplified signaling diagram according to further exemplary embodiments of the present invention.

FIGS. 13A and 13B schematically show a simplified signaling diagram according to further exemplary embodiments of the present invention.

FIG. 14 schematically shows aspects of uses according to further exemplary embodiments of the present invention.

### DETAILED DESCRIPTION OF EXAMPLE EMBODIMENTS

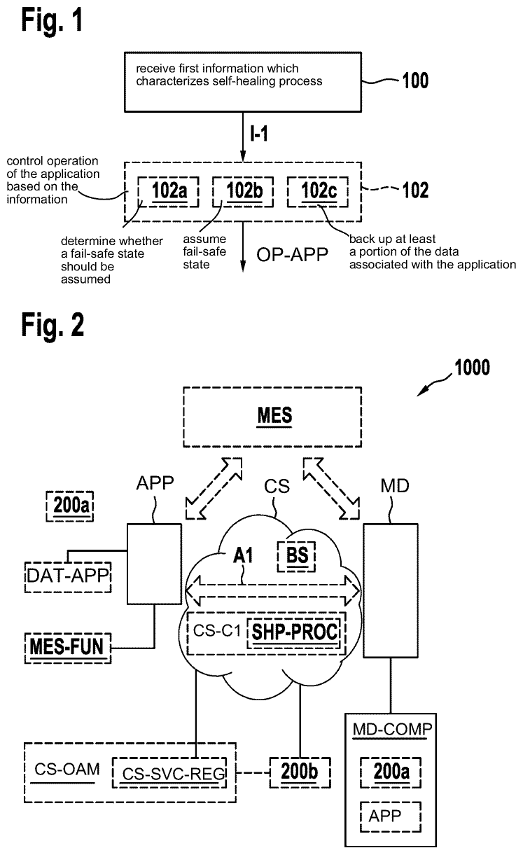

Exemplary embodiments, FIG. 1, relate to a method, for example a computer-implemented method, for processing data DAT-APP, see FIG. 2, associated with an application APP that at least intermittently uses a communication system CS for data exchange A1 with at least one other unit, for example a manufacturing device, MD, the method comprising: receiving 100 (FIG. 1) first information I-1 which characterizes a self-healing process SH-PROC, for example an imminent self-healing process or a self-healing process which is already being carried out, said self-healing process being associated with at least one component CS-C1 of the communication system CS, and, optionally, controlling 102 the operation OP-APP of the application APP on the basis of the first information I-1. As a result, in further exemplary embodiments, a possibly occurring self-healing process SH-PROC of at least one component CS-C1 of the communication system CS, which self-healing process could, for example, have an effect on the application APP, can be taken into account, e.g. for the operation OP-APP of the application APP.

For example, in further exemplary embodiments, the operation OP-APP of the application APP can thus be adapted to the self-healing process SH-PROC.

In further exemplary embodiments, FIG. 2, the application APP is associated with a manufacturing execution system, for example a manufacturing control system, MES, for example at least intermittently executes at least one function MES-FUN for the manufacturing execution system, for example the manufacturing control system, MES.

In further exemplary embodiments, FIG. 2, the communication system CS is e.g. a wireless, e.g. cellular, communication system, e.g. mobile communication system, e.g. according to a 4G (fourth generation) or 5G (fifth generation) standard, e.g. compatible with and/or based on 3GPP TS 32.541, or according to another standard, e.g. a future 6G standard.

In further exemplary embodiments, FIG. 2, the self-healing process SH-PROC can be designed, for example, according to and/or on the basis of 3GPP TS 32.541, Release 15; see e.g. 3GPP TS 32.541 V15.0.0 (2018-10), there e.g. FIG. 4.1.3-1.

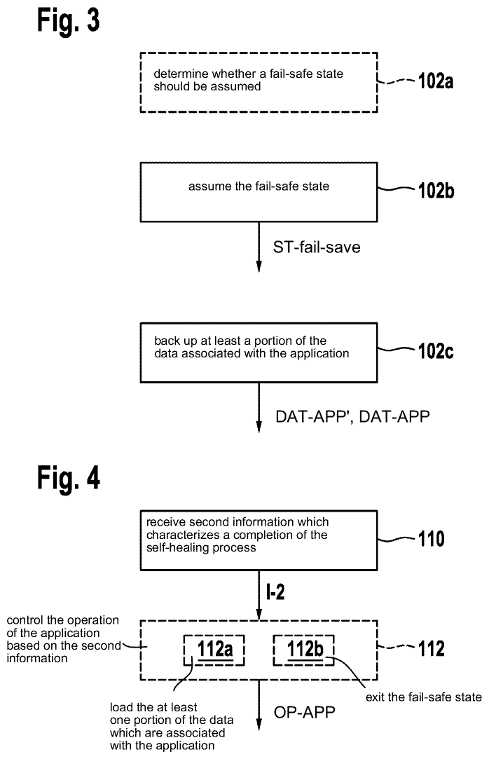

In further exemplary embodiments, see FIGS. 1 and 3, the optional controlling 102 comprises at least one of the following elements: a) determining 102a whether a fail-safe state, for example a failure-resistant state, should be assumed, for example for the application APP (FIG. 2) and/or at least one component MD-COMP, e.g. of a manufacturing device MD associated with the application APP (e.g. controlled by the application APP), and, optionally, assuming 102b (FIG. 3) the fail-safe state ST-fail-safe, b) backing up 102c at least one portion DAT-APP′ of the data DAT-APP which are associated with the application APP, wherein, for example, the at least one portion DAT-APP′ comprises, for example, configuration data and/or state data. In further exemplary embodiments, the backed-up data can be used, for example, for a transition of the application APP from a fail-safe state ST-fail-safe to a regular operating state, for example after a previously signaled self-healing process SH-PROC (FIG. 2) has been completed.

In further exemplary embodiments, FIG. 4, the method comprises: receiving 110 second information I-2 which characterizes a completion of the self-healing process SH-PROC associated with the at least one component CS-C1 of the communication system CS, and, optionally, controlling 112 the operation OP-APP of the application APP on the basis of the second information I-2.

In further exemplary embodiments, FIG. 4, the optional controlling 112 of the operation OP-APP of the application APP on the basis of the second information I-2 comprises at least one of the following elements: a) loading 112a the at least one portion DAT-APP′ of the data DAT-APP which are associated with the application APP, for example from a previous backup (see e.g. block 102c according to FIG. 3), b) exiting 112b the fail-safe state ST-fail-safe, for example switching from the fail-safe state ST-fail-safe to a regular operating state.

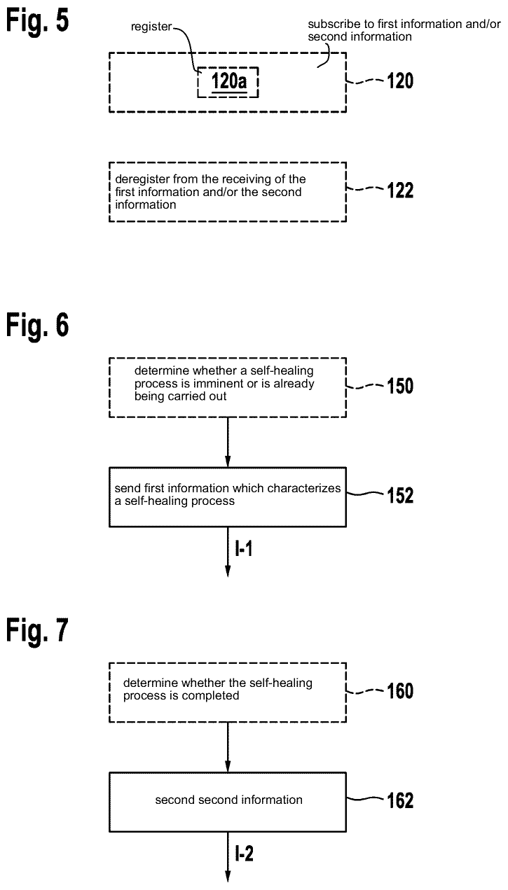

In further exemplary embodiments, FIG. 5, the method comprises at least one of the following elements: a) subscribing 120 to the first information I-1 and/or the second information I-2, for example registering 120a to receive the first information I-1 and/or the second information I-2, for example with at least one component, for example a service CS-SVC-REG (FIG. 2), of the communication system CS, b) deregistering 122 (FIG. 5) from receiving the first information I-1 and/or the second information I-2, for example with the at least one component, for example the service CS-SVC-REG, of the communication system CS. In some embodiments, the service CS-SVC-REG may, for example, be part of a device CS-OAM, said device being e.g. an operating and/or management component for the communication system CS.

Further exemplary embodiments, FIG. 6, relate to a method, for example a computer-implemented method, for processing data of a communication system CS (FIG. 2) that can be and/or is used at least intermittently by an application APP for data exchange A1 with at least one other unit, for example a manufacturing device, MD, the method comprising: sending 152 first information I-1 which characterizes a self-healing process SH-PROC associated with at least one component CS-C1 of the communication system CS, for example an imminent self-healing process or a self-healing process which is already being carried out, for example to the application APP.

In further exemplary embodiments, FIG. 6, the method comprises: determining 150 whether a self-healing process SH-PROC associated with at least one component CS-C1 of the communication system CS is imminent or is already being carried out.

In further exemplary embodiments, FIG. 7, the method comprises: determining 160 whether the self-healing process SH-PROC associated with the at least one component CS-C1 of the communication system CS is completed, and, optionally, sending 162 second information I-2, on the basis of the determining 160, for example to the application APP.

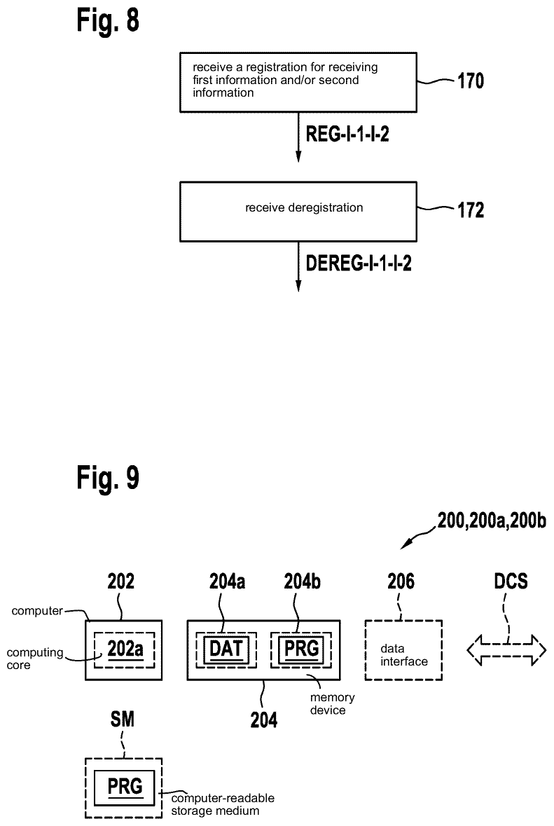

In further exemplary embodiments, FIG. 8, the method comprises at least one of the following elements: a) receiving 170 a registration REG-I-1-I-2 for receiving the first information I-1 and/or the second information I-2, e.g. from the application APP, b) receiving 172 a deregistration DEREG-I-1-I-2 from receiving the first information I-1 and/or the second information I-2, e.g. from the application APP.

Further exemplary embodiments, FIG. 9, relate to a device 200, 200a, 200b for performing the method according to at least one of the above-described example embodiments.

In further exemplary embodiments, the device 200, 200a, 200b comprises: a computing device (“computer”) 202 having at least one computing core 202a, and a memory device 204 assigned to the computing device 202, for at least temporarily storing at least one of the following elements: a) data DAT (e.g. data characterizing the first and/or second information I-1, I-2), b) computer program PRG, for example for performing the method according to the embodiments.

In further exemplary embodiments, the memory device 204 has a volatile memory (for example, working memory (RAM)) 204a, and/or a non-volatile (NVMV) memory (for example, flash EEPROM) 204b, or a combination thereof or with other types of memory not explicitly mentioned.

Further exemplary embodiments relate to a computer-readable storage medium SM comprising commands PRG that, when executed by a computer 202, cause said computer to perform the method according to the embodiments.

Further exemplary embodiments relate to a computer program PRG comprising commands that, when the program PRG is executed by a computer 202, cause said computer to carry out the method according to the embodiments.

Further exemplary embodiments relate to a data carrier signal DCS that characterizes and/or transmits the computer program PRG according to the embodiments. The data carrier signal DCS can be received, for example, via an optional data interface 206 of the device 200, 200a, 200b. Likewise, e.g. the first and/or second information I-1, I-2 or data characterizing it can be transferred (e.g. sent and/or received) via the optional data interface 206. In further exemplary embodiments, communication or data communication A1 with the at least one other unit MD (FIG. 2) can also take place via the optional data interface 206.

Further exemplary embodiments, FIG. 2, relate to a device MD-COMP for a manufacturing control system MES (FIG. 2) and/or a manufacturing device MD, comprising at least one device 200a according to the embodiments.

Further exemplary embodiments, FIG. 2, relate to a device for a communication system CS, comprising at least one device 200b according to the embodiments. For example, the device 200b can be associated with the operating and/or management component for the communication system CS.

In further exemplary embodiments, the device 200a (FIGS. 2 and 9) is designed, for example, to carry out at least one process according to at least one of FIGS. 1, 3, 4 and 5 and is associated, for example, with the application APP (FIG. 2). For example, in further exemplary embodiments, the device 200a can also be designed to execute functions of the application APP, e.g. at least one function MES-FUN for the manufacturing execution system, for example the manufacturing control system, MES.

In further exemplary embodiments, the device 200b (FIGS. 2 and 9) is designed, for example, to carry out at least one process according to at least one of FIGS. 6, 7 and 8 and is associated, for example, with the operating and/or management component for the communication system CS.

Further exemplary embodiments, FIG. 2, relate to a communication and manufacturing system, for example an integrated communication and production system, 1000, comprising at least one device 200, 200a, 200b according to the embodiments and/or at least one device MD-COMP for a manufacturing control system MES and/or a manufacturing device MD, optionally a or the manufacturing control system MES and/or the manufacturing device MD, and/or at least one device CS-OAM for a communication system CS, optionally the communication system.

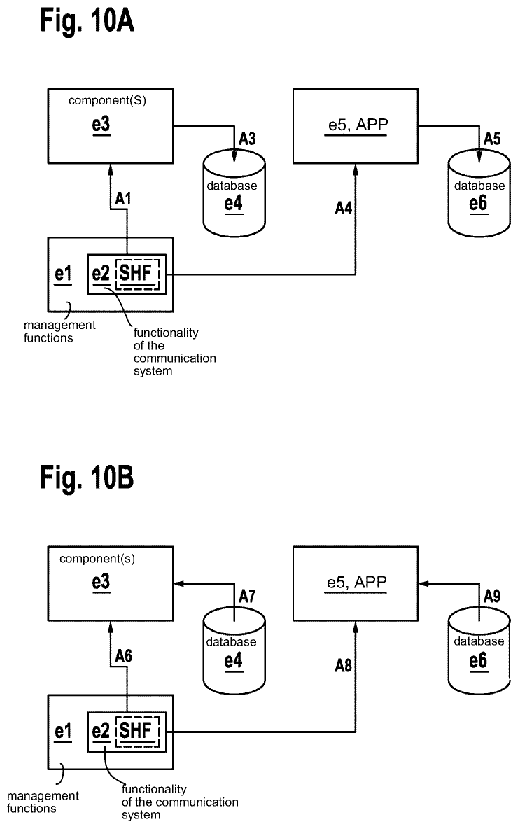

Below, further exemplary aspects and embodiments are described which, according to further exemplary embodiments, can be combined, individually or in any combination with one another, with at least one of the exemplary embodiments mentioned above. FIG. 10A and FIG. 10B each schematically show a simplified block diagram according to further exemplary embodiments in which the process described below by way of example can be carried out according to further exemplary embodiments.

Element e1 symbolizes management functions of the communication system CS (FIG. 2), element e2 symbolizes a functionality of the communication system CS regarding self-healing processes SH-PROC, for example compatible with and/or based on 3GPP TS 32.541, or according to another standard, for example a future 6G standard. For example, self-healing (SH) functions SHF associated with the element e2 monitor, for example repeatedly, for example periodically, for example continuously, one or more components of the communication system CS, for example including at least some of its network elements (e.g. base stations and/or terminals); see the arrow A2. In further exemplary embodiments, the monitoring can also be limited to a predefinable set of components, e.g. also to individual components.

In further exemplary embodiments, the self-healing (SH) functions associated with the element e2 detect a faulty element of the communication system CS or a (e.g. other) failure and signal the communication system or at least some components e3 (e.g. 5G PAN (radio access network) and 5G core) to back up information (e.g. configuration information and/or state information) that can be used for operation, e.g. important information; see the arrow A3. Element e4 symbolizes a database, e.g. of the communication system CS, which database can be used for the backup A3.

In further exemplary embodiments, the self-healing (SH) functions SHF associated with the element e2 inform the application e5, APP (see also FIG. 2) about a self-healing process SH-PROC associated with at least one component CS-C1 (FIG. 2) of the communication system CS, for example an imminent self-healing process or a self-healing process already being carried out, which e.g. affects or at least could affect the application (e.g. because the self-healing process can potentially impair the data exchange A1). The informing is symbolized in FIG. 10A with the arrow A4 and can, for example, comprise the first information I-1 according to FIG. 1. In further exemplary embodiments, the application e5, APP decides, on the basis of the information A4, to enter a fail-safe state. In further exemplary embodiments, the application e5, APP can, for example, back up at least one portion APP-DAT′ of the data APP-DAT which are associated with it or are or can be processed by it; see the arrow A5. The backup A5 can occur, for example, in a database e6 of the application APP, which database can be implemented, for example, in the memory device 204 (FIG. 9). For example, the backup A5 comprises the data that can be used, for example are required, for a transition from the fail-safe state to regular operation.

In further exemplary embodiments, FIG. 10B, the SH functions SHF trigger at least one self-healing process SH-PROC with respect to, for example, the component CS-C1 (e.g. affected by a failure); see the arrow A6. After the self-healing process SH-PROC, the completion of the self-healing process SH-PROC is recognized, for example, by the SH functions SHF, and the communication system CS or some of its components e3 load previously backed-up information (see the arrow A7), which can be used, e.g. is required, for resuming regular operation of the communication system CS.

Alternatively or in addition to restoring a function of a component of the communication system CS, a self-healing process SH-PROC can, for example, also comprise an alternative measure, e.g. for fault isolation, e.g. can comprise isolation of a faulty component.

In further exemplary embodiments, the SH functions SHF inform the application e5, APP about a successful restoration (and/or possibly another measure, e.g. for fault isolation), for example a successful completion of a self-healing process SH-PROC; see the arrow A8. Optionally, the application e5, APP can reload previously backed-up data or information (see the arrow A9), whereby, for example, a quick transition to regular operation of the application e5, APP is made possible. Thus, in further exemplary embodiments, the application e5, APP can resume its regular operation, e.g. for controlling the manufacturing device MD (FIG. 2), immediately after the completion of the self-healing process.

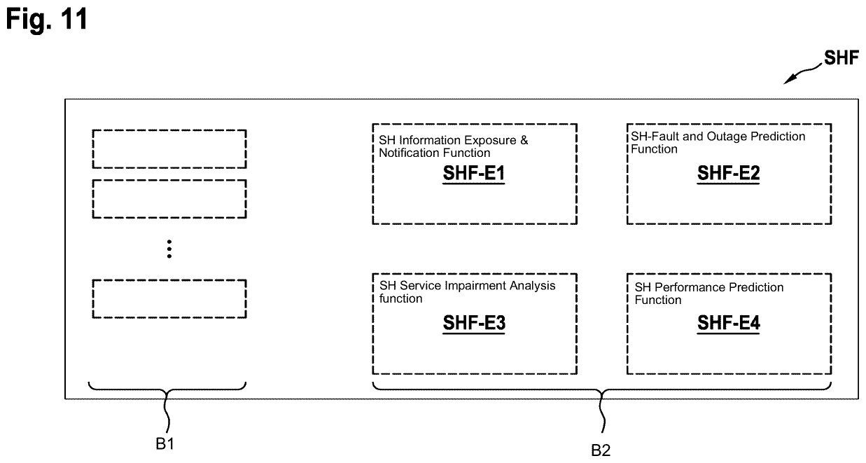

FIG. 11 schematically shows exemplary SH functions according to further exemplary embodiments, as can be provided in further exemplary embodiments, for example by the element e2 according to FIG. 10A, 10B and/or the component CS-OAM according to FIG. 2.

At least some of the SH functions described below by way of example with reference to FIG. 11 can be used, for example, for coupling self-healing aspects or self-healing processes of the communication system CS with the application e5, APP.

Bracket B1 symbolizes, by way of example, SH functions and/or aspects which are provided, for example, in 3GPP TS 32.541, e.g. for the communication system CS.

On the other hand, bracket B2 symbolizes, by way of example, further SH functions and/or aspects according to further exemplary embodiments.

In further exemplary embodiments, SHF-E1 symbolizes a function that can, for example, also be referred to as “SH Information Exposure & Notification Function” (SH_IEN_F). The function SHF-E1 is designed, for example, to manage subscriptions of the application(s) APP (e.g. for the transmission of information I-1, I-2) and/or to exchange information, e.g. about imminent self-healing processes or self-healing processes which are being carried out, e.g. in the form of the first information I-1 and/or the second information I-2. In further exemplary embodiments, applications APP can register, e.g. by means of a publish-subscribe mechanism, to receive information (e.g. the information I-1, I-2).

In further exemplary embodiments, details of the subscription or a registration which, for example, specify which information the application wants to receive can depend on several, e.g. many, factors, e.g. comprising at least one of the following elements: a) type of communication service used by the application APP, b) set of base stations to which the application APP connects, e.g. during its operating duration, c) degree of reliability that the application APP expects from the communication system CS, etc.

In further exemplary embodiments, the elements a), b), c) mentioned above as examples can also be used, for example, for at least one further function SHF-E3 (which e.g. can also be referred to as “SH Service Impairment Analysis Function”, SH_SIA_F; details below), e.g. to determine a degree of impairment, e.g. how strongly a self-healing process SH-PROC impairs communication performance for a specific application APP.

In further exemplary embodiments, the function SHF-E1 (SH_IEN_F) can also be designed, for example, to inform at least one application APP that the communication system CS is (again) working properly (or, for example, to what extent the communication system CS is (again) working properly), e.g. to signal completion or success or partial success of a self-healing process SH-PROC, for example using the second information I-2.

In further exemplary embodiments, SHF-E2 symbolizes a function which, for example, can also be referred to as “SH Fault and Outage Prediction Function” (SH_FOP_F). The SHF-E2 function is designed, for example, to determine, for example to predict, an occurrence of a fault or failure, e.g. of at least one component of the communication system CS (e.g. with regard to the probability and/or duration until the occurrence and/or duration of the persistence of the fault), for example on the basis of different information and/or measurements that are possible or available in the area of the communication system CS. In further exemplary embodiments, the prediction is carried out, for example, by means of at least one machine learning (ML) method, and, in further exemplary embodiments, the results of the prediction can be provided to the application APP, for example by the function SHF-E2. As a result, the application APP can, for example, also take or execute proactive measures, e.g. switching to another communication service for data exchange A1 (FIG. 2) and/or moving to another position where the current communication service may offer greater reliability.

In further exemplary embodiments, SHF-E3 symbolizes a function that can, for example, also be referred to as “SH Service Impairment Analysis Function” (SH_SIA_F). The function SHF-E3 is designed, for example, to determine, for example to analyze, to what degree a certain application APP is affected by a self-healing process SH-PROC which is imminent or which is already being carried out, e.g. affected either directly, e.g. because the application APP or a device MD associated with it is connected to a malfunctioning component of the communication system CS, or e.g. indirectly, e.g. because the application APP or a device MD associated with it is connected to a base station BS (FIG. 2) which, for example, is currently helping to compensate for a failure of another base station (not shown). In further exemplary embodiments, a degree of impact or impairment in the sense mentioned above can, for example, be quantized as a probability with which requirements of the application APP with regard to a communication service cannot be met by the communication system CS (e.g. packet error rate (PER), latency, data rate), e.g. with respect to requirements of the application APP with regard to a predefinable reliability (e.g. characterizable by a mean time between failures (MTBF), a required operating time, a probability of a fault in a predefinable period of time).

In further exemplary embodiments, a quantized degree of impact or impairment, e.g. from the function SHF-E3 or SH_IEN_F, can be used to signal to the application APP that it will be affected; see e.g. the first information I-1 according to FIG. 1.

In further exemplary embodiments, the function SHF-E3 or SH_IEN_F can, for example, directly make the quantized degree of impact or impairment available, for example in the form of the first information I-1, on the basis of which the application APP can, for example, determine whether it reacts to the first information I-1, e.g. carries out an action, e.g. selecting another communication service and/or changing the position and/or requesting a handover (e.g. to another base station) and/or entering the fail-safe state.

In further exemplary embodiments, the function SHF-E3 or SH_IEN_F can, for example, also use historical information, e.g. information already available from previous events, e.g. to determine the extent to which a self-healing process SH-PROC of the communication system CS can impair proper operation of the application APP. For example, the degree of impact or impairment can be determined using ML-based methods.

In further exemplary embodiments, SHF-E4 symbolizes a function which, for example, can also be referred to as “SH Performance Prediction Function” (SH_PPP_F). The function SHF-E4 is designed, for example, to provide information, for example additional information, regarding self-healing processes SH-PROC which are imminent or already being carried out, which self-healing processes may, for example, be of importance for the application APP. In further exemplary embodiments, such additional information can comprise, for example, at least one of the following elements: a) expected duration of a self-healing process SH-PROC, b) probability that the self-healing process SH-PROC will be successful, c) probability that a faulty network element or other faulty component of the communication system CS will be isolated, etc. In further exemplary embodiments, the above-mentioned additional information, optionally combined with a degree, e.g. quantized degree, of impact or impairment (which, for example, can be provided by the function SH_SIA_F), can be used, for example by the application APP, to initiate one or more countermeasures already described above.

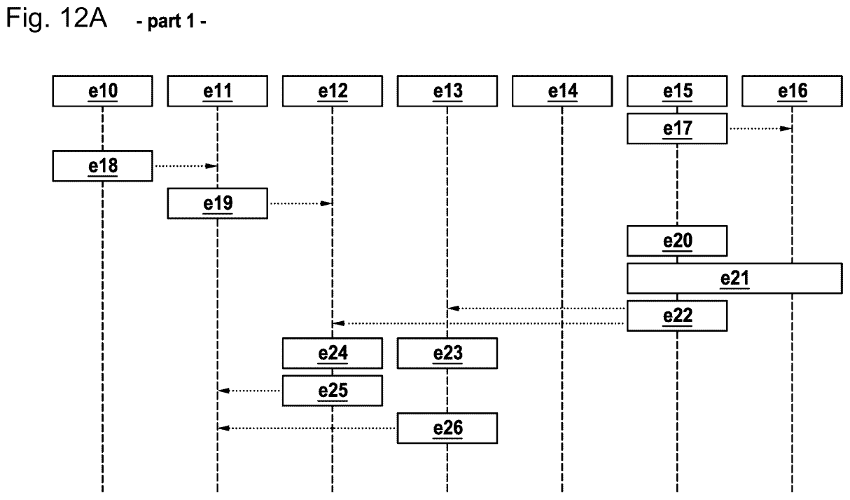

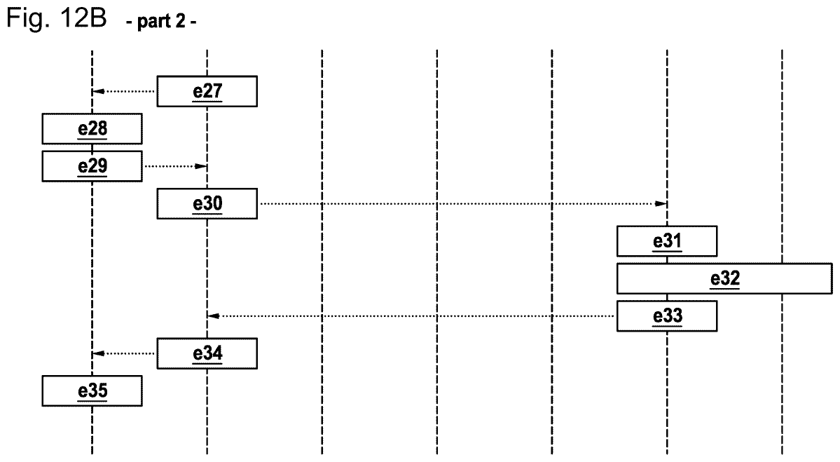

FIGS. 12A and 12B schematically show a simplified signaling diagram according to further exemplary embodiments. Element e10 symbolizes a manufacturing execution system, for example a manufacturing control system. Element e11 symbolizes the function SH_IEN_F already described above by way of example with reference to FIG. 11. Element e12 symbolizes the function SH_SIA_F already described above by way of example with reference to FIG. 11. Element e13 symbolizes the function SH_PPP_F already described above by way of example with reference to FIG. 11. Element e14 symbolizes the function SH_FOP_F already described above by way of example with reference to FIG. 11. Element e15 symbolizes further SH functions already described above by way of example, e.g. according to or based on or compatible with a 3GPP standard. Element e16 symbolizes a communication system, e.g. similar or comparable to the communication system CS according to FIG. 2.

Element e17 symbolizes a beginning of monitoring of the communication system e16 by the SH functions e15. Element e18 symbolizes a registration (e.g. subscription) of the MES e10 with the function e11, e.g. for the receipt of the first information I-1 (FIG. 1), e.g. which can be provided by means of the function e12. Element E19 symbolizes a registration of the MES with the function e12 by means of the function e11. Element e20 symbolizes a detection of a faulty network element of the communication system e16. Element e21 symbolizes aspects of a self-healing process SH-PROC of the communication system e16; see also e.g. the arrow A3 according to FIG. 11. Element e22 symbolizes the transmission of information about an imminent self-healing process SH-PROC of the communication system e16 to the functions e12, e13. Element e23 symbolizes the determining, e.g. estimating, of a duration of the imminent self-healing process SH-PROC. Element e24 symbolizes the determining, e.g. estimating, of a degree of impairment of at least one component of the MES e10, e.g. of an application APP (FIG. 2) of the MES e10. Element e25 symbolizes the signaling, e.g. reporting, of the determined degree of impairment. Element e26 symbolizes the signaling, e.g. reporting, of the duration of the imminent self-healing process SH-PROC. Element e27 symbolizes the informing of the MES e10 by the function e11, e.g. on the basis of the reports e25, e26, e.g. in the form of the first information I-1 (FIG. 1). Element e28 symbolizes the execution of countermeasures or protective measures, e.g. the assumption of a fail-safe state. Element e29 symbolizes the informing of the function e11 by the MES e10 about the execution e28 of the protective measures. Element e30 symbolizes the informing of the e.g. 3GPP-compliant SH functions e15 about the execution e28 of the protective measures or about a completion of the execution e28 of the protective measures by the MES e10. Element e31 symbolizes the initiation of the self-healing process SH-PROC by the SH functions e15. Element e32 symbolizes e.g. 3GPP-compliant aspects of the self-healing process SH-PROC, e.g. the triggering of the self-healing process SH-PROC in at least one faulty component of the communication system e16 and/or the transition to regular operation, e.g. after successful self-healing process SH-PROC. Element e33 symbolizes the informing of the function e11 by the SH functions e15 about the successfully completed self-healing process(es) SH-PROC. Element e34 symbolizes the informing of the MES e10 by the function e11 that the communication system e16 has successfully completed the self-healing process SH-PROC. Element e35 symbolizes the resumption of a function of the MES, e.g. regular operation of at least one application APP of the MES, which application, for example, controls a manufacturing device MD.

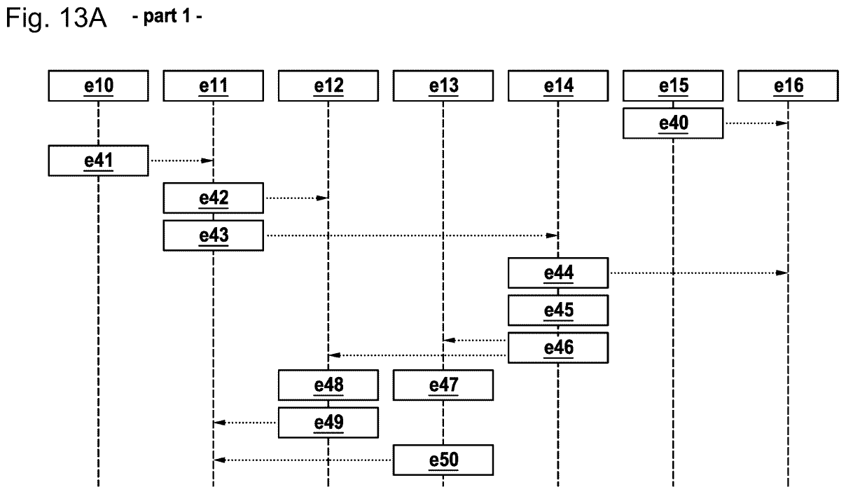

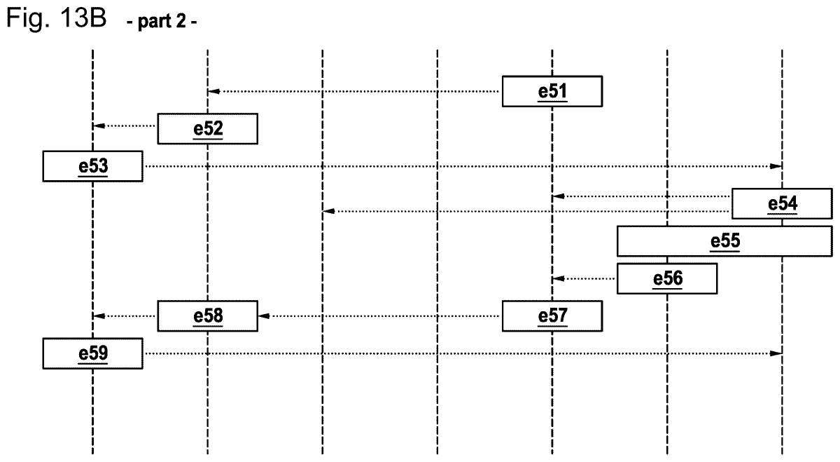

FIGS. 13A and 13B schematically show a simplified signaling diagram according to further exemplary embodiments. Element e40 symbolizes a beginning of monitoring of the communication system e16 by the SH functions e15, e.g. similarly to element e17 according to FIGS. 12A and 12B. Element e41 symbolizes a registration (e.g. subscription) of the MES e10 with the function e11, e.g. for the receipt of the first information I-1 (FIG. 1), e.g. which can be provided by means of the functions e12 and e14 (“SH_SIA_F and SH_FOP_F”). Element e42 symbolizes a registration of the MES with the function e12 by means of the function e11. Element e43 symbolizes a registration of the MES with the function e14 by means of the function e11. Element e44 symbolizes a beginning of monitoring of the communication system e16 by the function e14. Element e45 symbolizes the predicting of a future failure of a component of the communication system e16, for example a base station BS associated with the MES e10 (e.g. providing a component of the MES e10 with a communication service) (FIG. 2). Element e46 symbolizes informing the functions e13, e14 about the predicted future failure. Element e47 symbolizes the determining, e.g. estimating, of a duration of an imminent self-healing process SH-PROC. Element e48 symbolizes the determining, e.g. estimating, of a degree of impairment of at least one component of the MES e10, e.g. of an application APP (FIG. 2) of the MES e10. Element e49 symbolizes the signaling, e.g. reporting, of the determined degree of impairment. Element e50 symbolizes the signaling, e.g. reporting, of the duration of the imminent self-healing process SH-PROC. Element e51 symbolizes the signaling, e.g. reporting, of information of function e14 regarding e.g. the information determined in block e45. Element e52 symbolizes the informing of the MES e10 by the function e11, e.g. on the basis of the reports e49, e50, e51, e.g. in the form of the first information I-1 (FIG. 1). Element e53 symbolizes the execution of countermeasures or protective measures, e.g. the proactive request of a handover to another base station. Element e54 symbolizes the reporting of a configuration change for the MES e10, e.g. after successful handover. Element e55 symbolizes e.g. 3GPP-compliant aspects of the self-healing process SH-PROC, e.g. the detection of an imminent failure, e.g. of the base station mentioned, optional backing up of information (e.g. characterizing the state and/or configuration), the triggering of the self-healing process SH-PROC in at least one faulty component of the communication system e16 and/or the transition to regular operation, e.g. after successful self-healing process SH-PROC, and optionally the loading of any previously backed-up information. Element e56 symbolizes the informing of the function e14 about the successfully completed self-healing process(es) SH-PROC. Element e57 symbolizes the informing of the MES e10 by the function e14 that the communication system e16 has successfully completed the self-healing process SH-PROC. Element e58 symbolizes the informing of the MES e10 by the function e11 that the communication system e16 is working properly again. Element e59 symbolizes the requesting of a (further) handover, for example back to the originally used base station of the communication system e16.

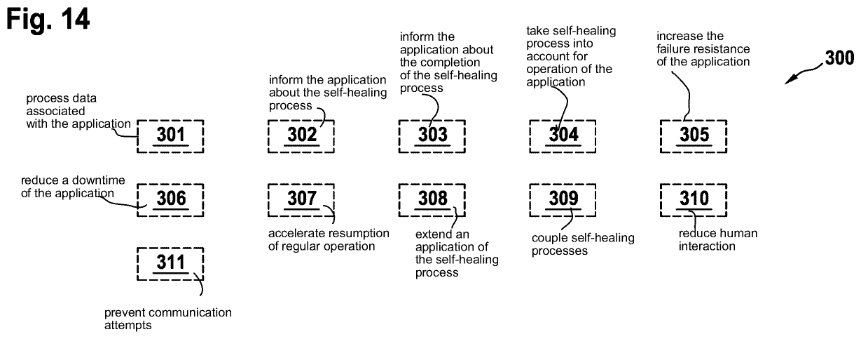

Further exemplary embodiments, FIG. 14, relate to a use 300 of the method according to the embodiments and/or of the device 200, 200a, 200b, MD-COMP, CS-OAM according to the embodiments and/or of the communication and manufacturing system 1000 according to the embodiments and/or of the computer-readable storage medium SM according to the embodiments and/or of the computer program PRG according to the embodiments and/or of the data carrier signal DCS according to the embodiments for at least one of the following elements: a) processing 301 data DAT-APP associated with an application APP that at least intermittently uses a communication system CS for data exchange A1 with at least one other unit, for example a manufacturing device, MD, b) informing 302 the application APP about the self-healing process SH-PROC, c) informing 303 the application APP about a completion of the self-healing process SH-PROC, d) taking 304 the self-healing process SH-PROC into account for operation OP-APP of the application APP, e) increasing 305 the failure resistance of the application APP, f) reducing 306 a downtime of the application APP, for example minimizing a downtime of the application APP due to a fault in the area of the communication system CS, g) accelerating 307 a resumption of regular operation of the application APP, for example after a self-healing process SH-PROC of the communication system CS, h) extending 308 an application of self-healing processes SH-PROC which are associated with the communication system CS to the application APP or the manufacturing device MD, i) coupling 309 self-healing processes SH-PROC which are associated with the communication system CS to the application APP and/or the manufacturing device MD and/or a or the manufacturing execution system, for example a manufacturing control system, MES, j) reducing 310, for example minimizing, human interaction or intervention, for example to transfer the application APP to a regular operating state, k) preventing 311 communication attempts, for example a number of communication attempts exceeding a predefinable amount of communication attempts, of the application APP, e.g. in the event of a fault in the area of the communication system CS.

The principle according to the embodiments enables efficient coupling of the communication system CS, e16, for example with regard to SH functions, which can be implemented e.g. by means of at least one component CS-OAM of the communication system CS, to the system MES (FIG. 1). As a result, in further exemplary embodiments, it is possible to minimize a downtime which the communication system CS (or its possibly existing self-healing processes SH-PROC) causes for an application APP of the system MES, which application controls e.g. a machine, for example a robot, of a manufacturing device MD. Furthermore, in further exemplary embodiments, a possibly required human intervention for restoring regular operation of the application APP can be minimized. In addition, in further exemplary embodiments, the application APP can be prevented from, for example, continuously attempting to communicate via the communication system CS, for example while a self-healing process SH-PROC is being executed; this reduces overhead.

In further exemplary embodiments, existing or planned telecommunications standards, such as 3GPP TS 32.541, can, for example, be supplemented by one or more aspects according to the embodiments, thereby enabling efficient applications APP that use communication systems CS, with increased reliability and/or lower latency.

1-18. (canceled)

19. A computer-implemented method for processing data associated with an application that at least intermittently uses a communication system for data exchange with at least one other unit, the method comprising:
receiving first information which characterizes a self-healing process associated with at least one component of the communication system; and
controlling operation of the application based on the first information.

20. The method according to claim 19, wherein the at least one other unit includes a manufacturing device.

21. The method according to claim 19, wherein the application is associated with a manufacturing execution system and at least intermittently executes at least one function for the manufacturing execution system.

22. The method according to claim 19, wherein the controlling includes at least one of the following elements: a) determining whether a fail-safe state should be assumed, and optionally assuming the fail-safe state, b) backing up at least one portion of data which are associated with the application, wherein the at least one portion includes configuration data and/or state data.

23. The method according to claim 22, further comprising:
receiving second information which characterizes a completion of the self-healing process associated with the at least one component of the communication system; and
controlling the operation of the application based on the second information.

24. The method according to claim 23, wherein the controlling of the operation of the application based on the second information includes at least one of the following elements: a) loading the at least one portion of data which are associated with the application from a previous backup, b) exiting the fail-safe state by switching from the fail-safe state to a regular operating state.

25. The method according to claim 23, further comprising at least one of the following elements: a) subscribing to the first information and/or the second information by registering to receive the first information and/or the second information with a service of the communication system, b) deregistering from receiving the first information and/or the second information with the service of the communication system.

26. A computer-implemented method for processing data of a communication system that can be and/or is used at least intermittently by an application for data exchange with at least one other unit, the method comprising:
sending first information which characterizes a self-healing process associated with at least one component of the communication system to the application.

27. The method according to claim 26, further comprising: determining whether the self-healing process associated with the at least one component of the communication system is imminent or is already being carried out.

28. The method according to claim 26, further comprising:
determining whether the self-healing process associated with the at least one component of the communication system is completed; and
optionally sending second information to the application based on the determining.

29. The method according to claim 28, further comprising at least one of the following elements: a) receiving a registration for receiving the first information and/or the second information, from the application, b) receiving a deregistration from receiving the first information and/or the second information, from the application.

30. A device for processing data associated with an application that at least intermittently uses a communication system for data exchange with at least one other unit, the device configured to:
receive first information which characterizes a self-healing process associated with at least one component of the communication system; and
control operation of the application based on the first information.

31. The device according to claim 30, wherein the device is included in a device OMP) for a manufacturing control system and/or a manufacturing device.

32. The device according to claim 30, wherein the device is for the communication system.

33. The device according to claim 30, wherein the device is included in an integrated communication and production system, which also includes a manufacturing control system and/or a manufacturing device.

34. A non-transitory computer-readable storage medium on which are stored commands for processing data associated with an application that at least intermittently uses a communication system for data exchange with at least one other unit, the commands, when executed by a computer, causing the computer to perform the following:
receiving first information which characterizes a self-healing process associated with at least one component of the communication system; and
controlling operation of the application based on the first information.

35. The method according to claim 19, wherein the method is used for at least one of the A use (300) of the method according to at least one of claims 1 to 10 and/or of the following elements: a) processing data associated with the application that at least intermittently uses the communication system for data exchange with the at least one other unit, b) informing the application about the self-healing process, c) informing the application about a completion of the self-healing process, d) taking the self-healing process into account for operation of the application, e) increasing a failure resistance of the application, f) reducing a downtime of the application that occurs due to a fault in an area of the communication system, g) accelerating a resumption of regular operation of the application after the self-healing process, h) extending an application of self-healing processes which are associated with the communication system to the application or a manufacturing device, i) coupling self-healing processes which are associated with the communication system to the application and/or the manufacturing device and/or a manufacturing control system, j) reducing human interaction or intervention to transfer the application to a regular operating state, k) preventing communication attempts of communication attempts of the application in the event of a fault in the area of the communication system.
